(19) United States
(12) Patent Application Publication
(10) Pub. No.: US 2004/0221020 A1
(43) Pub. Date: Nov. 4, 2004

(54) Method and system for communication system management

(75) Inventors: Susann Marie Keohane, Austin, TX (US); Gerald Francis McBrearty, Austin, TX (US); Shawn Patrick Mullen, Buda, TX (US); Jessica Kelley Murillo, Hutto, TX (US); Johnny Meng-Han Shieh, Austin, TX (US)

Correspondence Address: BRACEWELL & PATTERSON, L.L.P., P.O. BOX 969, AUSTIN, TX, 78767-0969, US

(73) Assignee: International Business Machines Corporation

(21) Appl. No.: 10/427,077

(22) Filed: Apr. 30, 2003

(51) Int. Cl. G06F 15/16

(52) U.S. Cl. 709/218; 709/228

(57) ABSTRACT

A method and system for controlling communication utilizing a pool of communication devices each capable of communicating at one or more multiple diverse predetermined data rates. Identifying indicia for each remote communication device attempting communication is stored in association with preferred data rate or range of data rates. Thereafter, subsequent attempts at communication by such remote communication devices are automatically coupled to a specific communication device within the pool having a compatible communications data rate.

### BACKGROUND OF THE INVENTION

1. Technical Field

The present invention relates to an improved communication system and in particular to an improved communication system for communication between remote communication devices and a pool of communication devices. Still more particularly the present invention relates to an improved communication system for communication between remote communication devices which communicate at diverse communications data rate and a pool of communication devices.

2. Description of the Related Art

The utilization of computers for communication has become increasingly widespread. Corporate entities, retail establishments, universities and other large organizations frequently provide data at a centrally located server and permit access to that data by selected individuals. Such access may be accomplished by means of a wired local network or, in the alternative, via a wide area network which may incorporate the Internet, the public switched telephone network or similar wide area networks.

Communication between two computers, such as a local or personal computer and a server storing the desired data can typically be accomplished over great distances utilizing a communication device such as a modulator/demodulator, commonly known as a “modem”. Such devices are capable of communication at many different data rates such as, for example, 14.4 kbps, 28.8 kbps, 33.6 kbps or 56 kbps. Modems capable of communicating at higher speed are typically more advanced and more costly to acquire. Consequently, an individual attempting to communicate with a remote server utilizing a modem device may have a substantial investment in maximizing the speed of data transmission. This is particularly true for services which charge a rate which is dependent upon the period of time which the user is connected.

In order to accommodate more than one subscriber or user at one time servers frequently incorporate a so-called “modem pool” which includes multiple modems which may be assigned to remote communicating devices for communication. Such assignment typically occurs on a “first come first serve” method and many of the modem devices within the pool may not be capable of a high speed communications data rate. As a result, a user who has invested in a high speed modem may find himself or herself connected by a means of a modem within the modem pool which is only capable of a substantially slower data rate.

It should therefore be apparent that a need exists for a method for enhancing communication via a pool of communication devices is such that the communication occurs at a desired data rate or within a desired data rate range.

### SUMMARY OF THE INVENTION

It is therefore one object of the present invention to provide an improved communication system.

It is another object of the present invention to provide an improved communication system for communication between remote communication devices and a pool of communication devices.

It is yet another object of the present invention to provide an improved communication system for communication between remote communication devices communicating at diverse communications data rates and a pool of communication devices.

The foregoing objects are achieved as is now described. A method and system are providing for controlling communication utilizing a pool of communication devices, such as modems, where each communication device is capable of communicating at one or more of multiple diverse predetermined data rates. Identifying indicia for each remote communication device attempting communication is stored in association with a preferred data rate or range of data rates. Thereafter, subsequent attempts at communication by such remote communication devices are automatically coupled to a specific communication device within the pool having a compatible communications data rate.

### BRIEF DESCRIPTION OF THE DRAWINGS

The novel features believed characteristics of the invention are set forth in the appended claims. The present invention itself, however, as well as a preferred mode of use, further objectives, and advantages thereof, will best be understood by reference to the following detailed description of a preferred embodiment when read in conjunction with the accompanying drawings, wherein:

FIG. 1 is a high level schematic diagram of a communication system embodying the method and system of the present invention;

FIG. 2 is a high level logic flow chart illustrating the method for communication in accordance with the method of the present invention; and

FIG. 3 is a schematic representation of a calling modem history maintained within storage of a controlled device which implements the method and system of the present invention.

### DETAILED DESCRIPTION OF THE PREFERRED EMBODIMENT

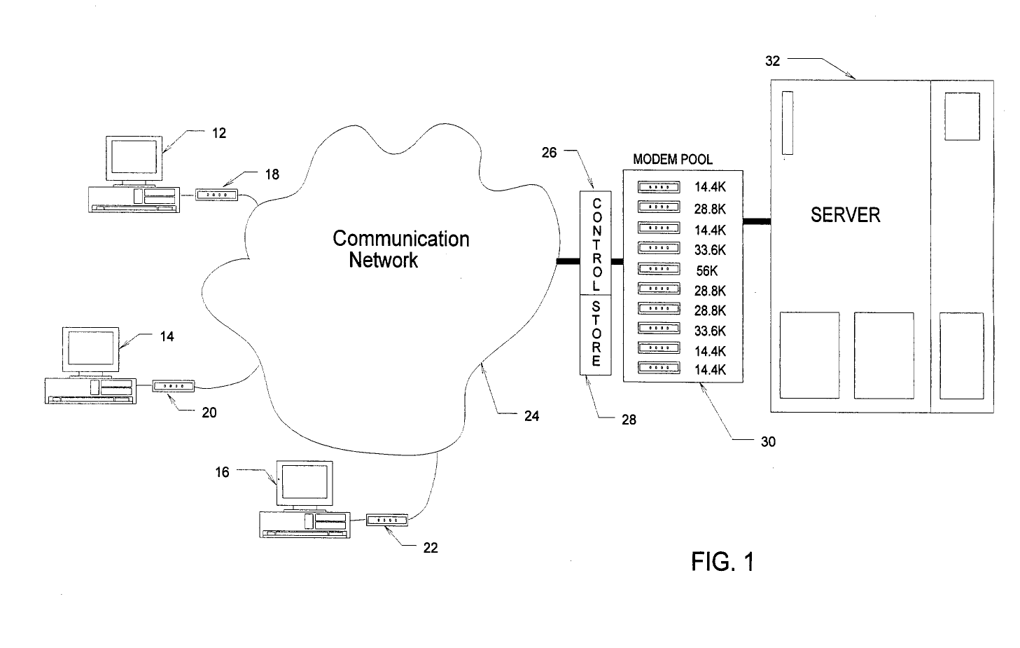

With reference now to the figures and in particular with reference FIG. 1 there is depicted is a high level schematic diagram of a communication system embodying the method and system of the present invention. As illustrated, multiple remote computers 12, 14 and 16 may be utilized to communicate with server 22 utilizing the method and system of the present invention. Remote computers 12, 14 and 16 may comprise terminals, personal computers, midlevel computers, workstations or any other suitable device capable of digital communication utilizing the method and system described herein.

As illustrated, each remote computer 12, 14 and 16 includes an associated communication device, 18, 20 and 22 respectively. Communication devices 18, 20 and 22 may comprise any suitable communication device capable communicating at various data rates such as, for example, a modulator/demodulator, or so-called “modem.”

Thus, as illustrated, each communication device may be coupled to server 32 via a communication network 24. Communication network 24 may comprise a wide area network, such as the Internet, or simply the public switched telephone network (PSTN). Communication utilizing a modem device and either of these alternatives is believed to be within the skill level of the ordinary skilled practitioner in this technology area and thus forms no part of the present disclosure.

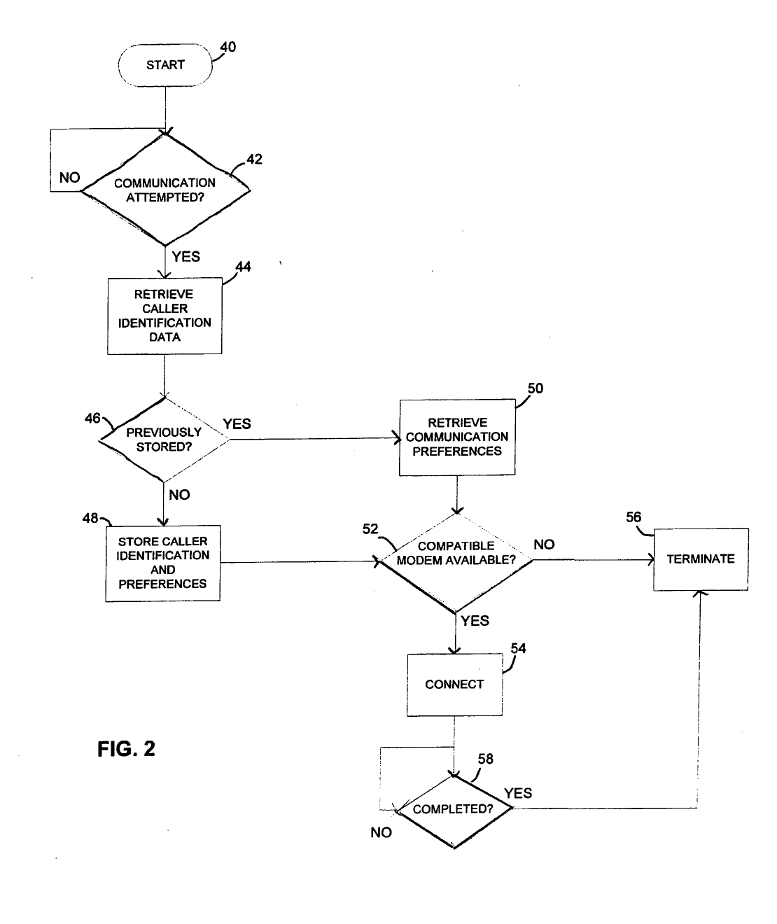

Next, communication passes from communication network 24 to modem pool 30 via a controller 26. Controller 26 is implemented utilizing any suitably programmed device capable of implementing the method as set forth in the high level logic flow chart of FIG. 2. Associated with controller 26 is store 28 which is utilized, as described herein, to store various identifying indicia and preferred communications data rates or ranges for various remote communication devices in order to implement the method and system of the present invention.

Next, communication passes via controller 26 to modem pool 30. As schematically depicted within FIG. 1, modem pool 30 comprises a large number of modems or other communication devices, some of which are capable of communicating a higher or lower communications data rate than other devices. As described above, communication utilizing a modem pool typically occurs by coupling an incoming communication to a modem within the pool on a “first come first serve” basis wherein most modems or communication devices within the pool are capable of communication at a higher data rate, but selected devices within the pool may not be capable of that data rate and are utilized when a large number of communication sessions occur simultaneously. Thereafter, as depicted within FIG. 1, the selected communication passes through a particular modem within modem pool 30 to server 32, completing the communication circuit so that data within server 32 may be retrieved, read or modified as well known in the art.

Referring now to FIG. 2 there is depicted a high level logic flow chart which illustrates the process whereby the method and system of the present invention may be implemented. As depicted, this process begins at block 40 and thereafter passes to block 42. Block 42 depicts a determination of whether or not a communication has been attempted and if not, the process merely iterates until such time as a communication attempt occurs.

Next, still referring to block 42, in the event a communication attempt occurs the process passes to block 44. Block 44 illustrates the retrieval of caller identification data or other identifying indicia associated with the remote computer attempting communication with the server. Those skilled in the art will appreciate that this may comprise so-called “caller identification” data provided by the public switched telephone network, network address or any other indicia which uniquely identifies a particular remote computer device.

Next, the process passed from block 44 to block 46. Block 46 depicts a determination of whether or not the caller identification or other identifying indicia has been previously stored and if not, the process passes to block 48. Block 48 illustrates the storing of the caller identification or other indicia for a particular remote computer and the communication preferences for that computer which are determined either automatically by means of a modem connect signal or explicitly, as entered by a user at a remote computer device.

Still referring to block 46, in the event the caller identification or other indicia have been previously stored, the process passes to block 50. Block 50 depicts the retrieval of the communication preferences for the particular remote computer associated with the caller identification or other identifying indicia.

Thereafter, after either retrieving the communication preferences or initially storing the communication preferences the process passes to block 52. Block 52 illustrates a determination of whether or not a compatible modem or other communication device is available. By “compatible” what is meant is a communication device capable of communicating at the preferred data rate for the particular remote computer attempting the present communication or a modem capable of communicating within a specified communications data rate range. If such a compatible modem is available the process passes to block 54.

Block 54 illustrates the connecting of the remote computer to the server for communication and the process thereafter passes to the block 58. Block 58 illustrates a determination of whether or not the present communication session has completed and if not, the process merely iterates until such time as the communication session has completed.

Referring again to block 52, in the event a modem which is compatible with the desired communications data rate or desired communication data rate range is not available, or, referring to block 58, in the event the communication session has completed, the process passes from block 52 or block 58 to block 56 which illustrates a termination of the communication session.

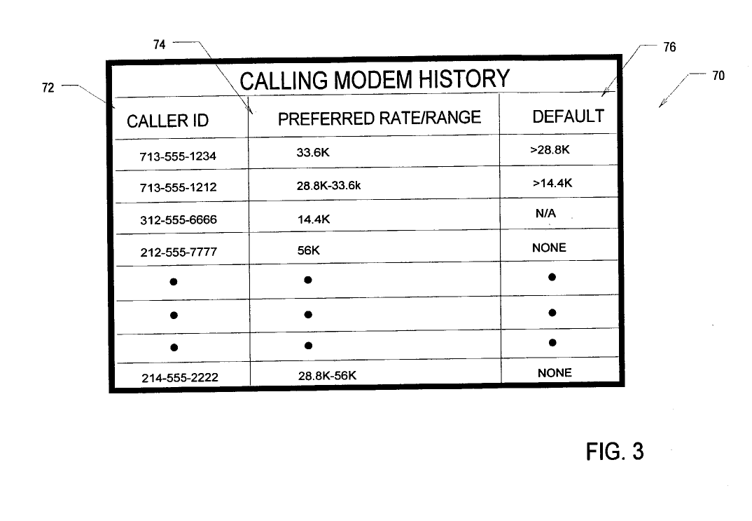

Finally, with reference to FIG. 3, there is depicted a schematic representation of a calling modem history 70 which may be stored within store 28 of controller 26 (see FIG. 1) in accordance with the method and system of the present invention. As illustrated, calling modem history 70 includes multiple forms of data utilized to implement the method and system of the present invention. Thus, column 72 of the depicted embodiment of calling modem history 70 is utilized to store identifying indicia for a particular personal computer, such as caller identification data. Of course, as noted above, network addresses or other unique identifying indicia may also be utilized. Additionally, preferred communication rates or communication rate ranges are stored within on column 74. As depicted, each personal computer has entered, either automatically via communication signals between modems or expressly after prompting a preferred data rate or range of data rates to be associated with the unique indicia for each particular remote computer. Finally, default conditions are stored within on column 76.

Thus, as depicted within the calling modem history 70 of FIG. 3, the remote computer associated with the caller id “713-555-1234” prefers a communications data rate of 33.6 kbps but will accept any communication device capable of communicating at a rate greater than 28.8 kbps. Similar, a remote computer associated with caller id “713-555-1212” prefers a communications data rate of between 28.5 kbps and 33.6 kbps but will accept any communications data rate which is greater than 14.4 kbps. In a like manner, the remote computer associated with caller identification “312-555-6666” has a preferred communications data rate of 14.4 kbps and, as this is the lowest communication speed provided, no default is provided. As a final example, the remote computer associated with caller identification “212-555-7777” has a preferred communications data rate of 56 kbps and, as depicted in FIG. 3, will accept no default status. Thus, the remote computer associated with this caller identification will communicate at 56 kbps or not at all.

As illustrated herein, the method and system of the present invention provides and enhanced communication technique whereby the efficiency of communication between remote communication devices and a pool of such communication devices may be enhanced by permitting each remote communication device to communicate at a data rate which has been selected as optimal by the user of that device or the device itself. In this manner, communication between remote computers and a server such as server 32 is greatly enhanced.

What is claimed is:

1. A method for enhanced communications via a pool of communication devices wherein each communication device within said pool communicates at one or more multiple diverse predetermined data rates, said method comprising the step of:
storing an indication of a preferred communications data rate in association with identifying indicia for each remote communication device communicating with said pool of communication devices in response to an attempt at communication by a remote communication device;
determining if a preferred communications data rate is stored for a particular remote communication device having selected identifying indicia in response to an attempt at communication by said particular remote communication device; and
automatically coupling said particular remote communication device to a specific communication device within said pool having a compatible communications data rate in response to an identification of a stored preferred communications data rate for said particular remote communication device.

2. The method for enhanced communication according to claim 1 wherein each remote communication device communicates with said pool of communication devices via a public switched telephone network and wherein said step of storing an indicia of a preferred communications data rate in association with identifying indicia for each remote communication device communicating with said pool of communication devices comprises the step of storing an indication of a preferred communications data rate in association with caller identification data provided by said public switched telephone network.

3. The method for enhanced communication according to claim 1 wherein said step of storing an indicia of a preferred communications data rate in association with identifying indicia for each remote communication device communicating with said pool of communication devices comprises a step of storing an indication of a preferred range of communications data rates in association with identifying indicia for each remote communication device with said pool of communication devices.

4. The method for enhanced communication according to claim 1 wherein said step of automatically coupling said particular remote communication device to a specific communication device within said pool having a compatible communications data rate in response to a identification of a stored preferred communications data rate for said particular remote communication device comprises the step of automatically coupling said particular remote communication device to a specific communication device within said pool having a communications data rate lower than said preferred communications data rate in response to an identification of a stored preferred communications data rate for said particular remote communication device.

5. The method for enhanced communication according to claim 1 further comprising the step of terminating communication with said particular remote communication device if no communication device within said pool has a compatible communications data rate.

6. A network communication system for communicating with multiple remote communication devices at one or more multiple diverse predetermined communications data rates, said system comprising:
a pool of multiple communication devices each capable of communicating at one or more multiple diverse predetermined data rates
data storage means for storing an indication of a preferred communications data rate in association with identifying indicia for each remote communication device communicating with said pool of communication devices in response to an attempt at communication by a remote communication device
determining if a preferred communications data rate is stored for a particular remote communication device having selected identifying indicia in response to an attempt at communication by said particular remote communication device; and
automatically coupling said particular remote communication device to a specific communication device within said pool having a compatible communications data rate in response to an identification of a stored preferred communications data rate for said particular remote communication device.

7. A network communication system according to claim 6 wherein communication occurs via a public switched telephone network and wherein said network communication system further includes means for receiving caller identification data from said public switched telephone network in response to an attempt at communication by a remote communication device.

8. A network communication system according to claim 6 wherein said pool of multiple communication devices comprises of a pool of modems.

9. A network communication system according to claim 6 wherein said data storage means stores an indication of a preferred range of communications data rates in association with identifying indicia for each remote communication device communicating with said pool of communication devices.

10. A network communication system according to claim 6 wherein said means for automatically coupling said particular remote communication device to a specific communication device within said pool having a compatible communications data rate in response to an identification of a stored preferred communications data rate for said particular remote communication device comprises a means for automatically coupling said particular remote communication device to a specific communication device within said pool having a communications data rate lower than said preferred communications data rate in response to an identification of a stored preferred communications data rate for said particular remote communication device.

11. A network communication system according to claim 6 further including means for terminating communication with said remote communication device if no communication device within said pool has a compatible communications data rate.

12. A computer program product for controlling communication via a pool of communication devices wherein each communication device within said pool communicates at one or more of multiple diverse predetermined data rates, said
computer program product comprising:
computer readable media;
instruction means embodied within said computer readable media for storing an indication of a preferred communications data rate in association with identifying-indicia for each remote communication device communicating with said pool of communication devices in response to an attempt at communication by a remote communication device;
instruction means embodied within said computer readable media for determining if a preferred communications data rate is stored for a particular remote communication device having selected identifying indicia in response to an attempt at communication by said particular remote communication device; and
instruction means embodied within said computer readable media for automatically coupling said particular remote communication device to a specific communication device within said pool having a compatible communications data rate in response to an identification of a stored preferred communications data rate for said particular remote communication device.
